(19) United States
(12) Patent Application Publication
(10) Pub. No.: US 2016/0010646 A1
(43) Pub. Date: Jan. 14, 2016

(54) ROTARY VANE PUMP FOR GENERATING A VACUUM

(71) Applicant: Joma-Polytec GmbH, Bodelshausen (DE)

(72) Inventors: Bernd Hess, Nurtingen (DE); Hans-Peter Ott, Hirrlingen (DE); Martin Thoma, Riederich (DE); Andreas Blank, Hechingen (DE); Torsten Helle, Tubingen (DE)

(73) Assignee: JOMA-POLYTEC GMBH, Bodelshausen (DE)

(21) Appl. No.: 14/793,790

(22) Filed: Jul. 8, 2015

(30) Foreign Application Priority Data
Jul. 8, 2014 (DE) 20 2014 005 520.3

(51) Int. Cl. F04C 29/00; H02K 7/14; F04C 18/344

(52) U.S. Cl. CPC F04C 29/0085; F04C 18/344; F04C 29/005; H02K 7/14

(57) ABSTRACT

A rotary vane pump for generating a vacuum, having an electric drive with a motor stator and a motor rotor, wherein the motor stator and the motor rotor radially encompass the pump housing. The motor stator is non-rotatably disposed around or on the pump housing. The motor rotor is disposed on the side of the motor stator facing away from the pump housing, such that an overall housing is provided that accommodates the electric drive and the pump housing, and the overall housing has a housing floor and a housing shell, wherein the housing floor, together with the pump housing delimits the pump chamber.

### CROSS-REFERENCE TO RELATED APPLICATIONS

The present application claims priority to and all the benefits of German Patent Application No. 20 2014 005 520.3, filed on Jul. 8, 2014, which is hereby expressly incorporated herein by reference in its entirety.

### BACKGROUND

1) Field of the Invention

The invention relates to a rotary vane pump for generating a vacuum, having a pump housing that delimits a pump chamber, having a rotatable pump rotor in the pump housing, and having at least one vane supported in the pump rotor that can be displaced radially, for dividing the pump chamber.

2) Description of the Related Art

Pumps of this type are known in a variety of forms from the prior art, e.g., from EP 2 002 084 B1, EP 1 931 879 B1 or DE 29 38 276 A1.

### SUMMARY OF THE INVENTION

Depending on the use of such a rotary vane pump, a drive may be provided for driving the pump rotor. The object of the invention is to further develop a rotary vane pump that can be driven appropriately, and in particular such that it takes up comparatively less structural space.

This objective is achieved in that an electric drive for driving the pump rotor is provided, wherein the electric drive has a motor stator and a motor rotor, and in that the motor stator and the motor rotor radially encompass the pump housing. A rotary vane pump can be provided with this assembly that is very compact. In particular, because the motor stator and motor rotor are disposed radially around the pump housing, it is conceivable to drive the pump rotor directly, without an intermediate gearing, from the motor rotor, or, respectively, to design the two rotors such that they are rotationally coupled.

It is advantageous when the pump rotor passes through the pump housing in an axial direction, for the rotational coupling with the motor rotor. A drive section of the pump rotor may be provided thereby that passes through the pump housing.

Furthermore, it is advantageous when the motor stator is non-rotatably disposed about or on the pump housing, and when the motor rotor is disposed on the side of the motor stator facing away from the pump housing. This results in a comparably compact construction. The pump housing can be provided thereby such that the motor stator is disposed in a non-rotatable manner. The motor stator thus encircles, in an annular manner, the pump housing. The motor rotor, conversely, is provided radially on the outside, in relation to the stator, and likewise preferably has an annular section encircling the motor stator.

In order to rotatably couple the motor rotor to the pump rotor, it is advantageous when the motor rotor comprises a rotational link covering the motor stator and the pump housing, which is rotatably coupled to the pump rotor in the region of its rotational axis. As a result, the rotational movement of the motor rotor can be transferred to the pump rotor in a suitable manner.

In another embodiment of the invention, the motor rotor is rotatably disposed between the pump housing and the motor stator. The motor stator can be non-rotatably disposed thereby in an overall housing. The motor stator can likewise be designed in an annular manner, and radially encompass the pump housing. An annular gap is then provided between the pump housing and the motor stator, in which the motor rotor is then provided between the pump housing and the motor stator. This also results in a comparatively compact construction.

It is also advantageous with this embodiment when the motor rotor comprises a rotational link that covers the pump housing, which is rotatably coupled to the pump rotor in the region of its rotational axis.

The rotational link is preferably designed in the shape of a bell, wherein the shell of the bell radially encompasses the pump housing and, if applicable, the motor stator. The rotational link is then preferably rotatably coupled directly to the pump rotor in the region of the rotational axis.

Preferably, there are permanent magnets, which can have coils that can be supplied with electrical current, provided on the rotational link, that interact with the motor stator.

An overall housing is provided, that accommodates the electric drive and the pump housing, which can have a housing floor and a housing shell. The overall housing fully encapsulates, in particular, the electric drive and the pump housing thereby.

The pump chamber is open toward the housing floor thereby, such that the housing floor, together with the pump housing, delimits the pump chamber. The housing floor can be designed in the manner of a cap thereby.

The housing shell can have a casing section and a cover section, wherein the casing section radially encompasses the motor stator, the motor rotor and the rotational link, wherein the cover section covers, axially, the motor stator, the motor rotor and the rotational link. The housing shell can be designed, on the whole, in the manner of a cap, such that when the housing shell is placed on the housing floor, a closed overall housing is obtained on the whole.

The pump rotor can be designed such that its end facing the housing floor is rotatably supported in the housing floor, and its end facing away from the housing floor is rotatably supported in the pump housing. The pump housing as such can be attached to the housing floor by fasteners, such as screws, in particular. Depending on the embodiment, the motor stator can be non-rotatably disposed on the pump housing or on the housing floor.

Furthermore, it is advantageous when the vacuum side of the pump chamber is connected to a vacuum connection, via a pressure channel provided, in particular, in the housing floor, and/or when the pressure side of the pump chamber is connected to a pressure connection, via a pressure channel provided, in particular, in the housing floor. Preferably, there are thus two pressure channels provided in the housing floor, one for the vacuum connection, and one for a pressure connection. It is conceivable, in particular, that the housing floor is provided with a recess for the vacuum connection, wherein a check valve can be provided on or in the vacuum connection.

It is advantageous thereby when the housing floor, the pump housing, the rotor and/or the at least one vane are made of plastic.

Furthermore, such pumps may be used in dry operation, as well as for an operation with a minimum of lubrication, thus distinguishing them from previous pumps that have been driven electrically.

### BRIEF DESCRIPTION OF THE DRAWINGS

Further details and advantageous designs of the invention can be derived from the following description, in which two exemplary embodiments of the invention shown in the figures are described and explained in greater detail, wherein:

FIG. 1 is a side view of a rotary vane pump of the present invention;

FIG. 2 is a plan view of the rotary vane pump according to FIG. 1;

FIG. 3 is a cross-sectional view taken along the lines III-III of FIG. 2, through a first embodiment;

FIG. 4 is a cross-sectional view taken along the lines IV-IV of FIG. 2;

FIG. 5 is a cross-sectional view taken along the lines V-V of FIG. 2;

FIG. 6 is a cross-sectional view taken along the lines VI-VI of FIG. 2, through a second embodiment;

FIG. 7 is a cross-sectional view taken along the lines VII-VII of FIG. 2; and

FIG. 8 is a cross-sectional view taken along the lines VIII-VIII of FIG. 2.

### DETAILED DESCRIPTION OF THE INVENTION

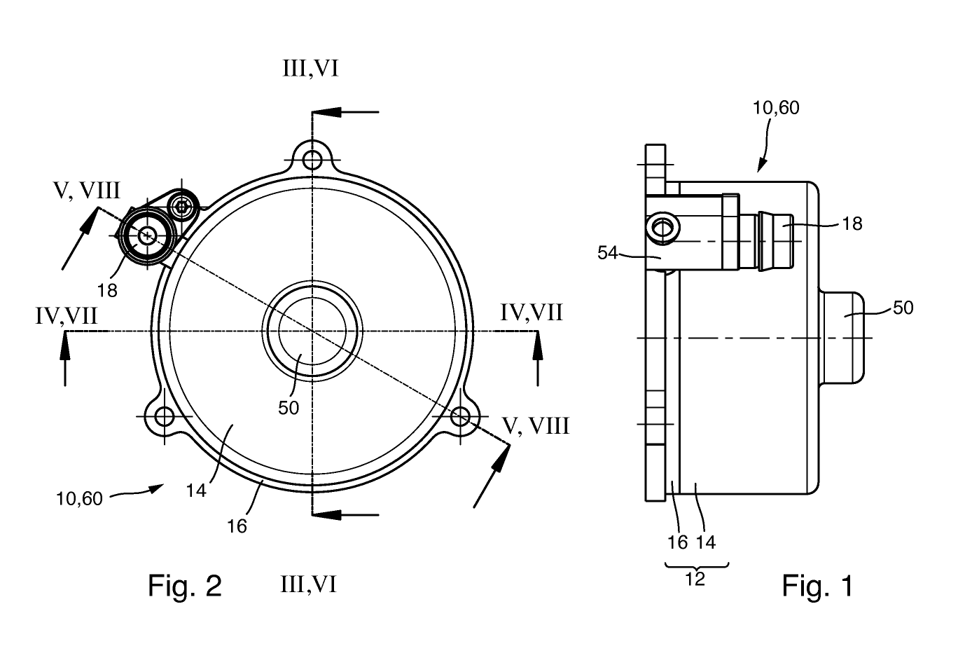

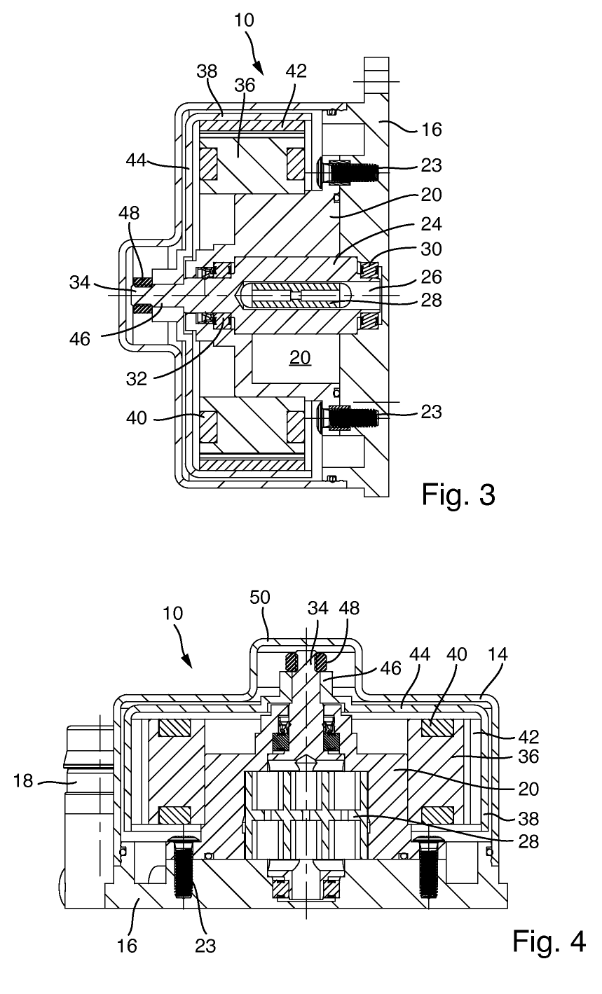

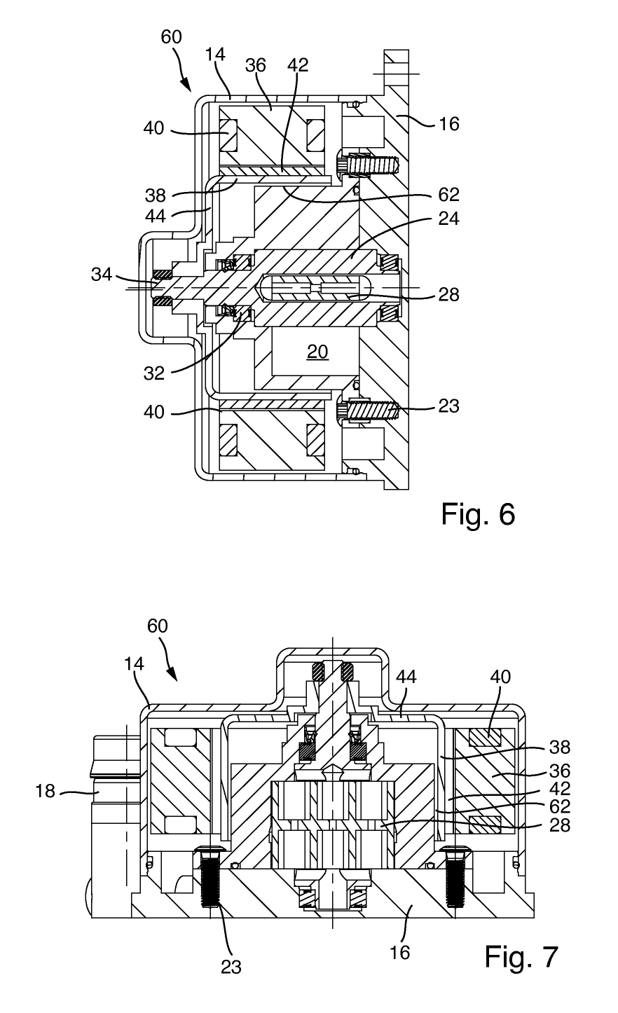

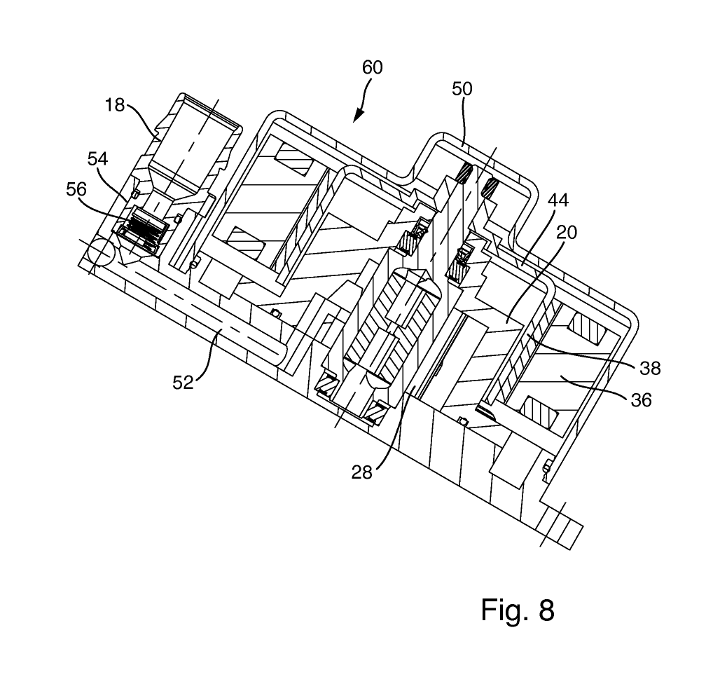

The rotary vane pump 10, 60 shown in FIGS. 1 and 2 includes an overall housing 12, composed of a housing shell 14 and a housing floor 16. A vacuum connection 18 is formed on the housing floor 16, through which air is suctioned off when the rotary vane pump 10, 60 is in operation. While the first embodiment of a rotary vane pump 10 is shown in FIGS. 3 to 5, a second embodiment of a rotary vane pump 60 is shown in FIGS. 6 to 8.

A pump housing 22 that delimits a pump chamber 20 can be clearly seen in the sections illustrated in FIGS. 3 to 5. A pump rotor 24 is provided in the pump chamber 20, which can rotate about a rotational axis 26. A vane 28 that is supported such that it can be displaced radially is provided in the pump rotor 24, which divides the pump chamber 20 into a suction section and a pressure section. The pump chamber 20 is disposed eccentrically to the rotational axis 28 thereby. As is clear, in particular, from FIGS. 3 and 4, the pump housing 22 is attached to the housing floor 16 via fastening screws.

As is likewise clear from FIGS. 3 to 5, the pump rotor 24 is, on one hand, rotatably supported in the housing floor 16 by a bearing 30. On the other hand, the pump rotor 24 is rotatably supported in the pump housing 22 by another bearing 32. The rotor 24 has a drive section 34 passing through the pump housing 20 on its side facing away from the housing floor 16.

An electric drive is provided in the overall housing 12 for driving the rotor 24, which comprises a motor stator 36 and a motor rotor 38. The motor stator 36, which comprises coil windings 40, is non-rotatably disposed in the radial outer surface of the pump housing 20. The motor rotor 38 radially encompasses the motor stator 36 thereby, and rests on the side of the motor stator 36 facing away from the pump housing 20. Permanent magnets 42 are provided on the inner surface of the rotor 38 facing the motor stator 36, which interact with the stator 36, or its windings 40, respectively, in order to rotate the rotor when the rotary vane pump 10 is in operation.

As is likewise clear from FIGS. 3 to 5, the motor rotor 38 is designed as a bell-shaped rotational link that covers the motor stator 36 and the pump housing 20. The rotational link 44 has an opening 46 in the region of the central longitudinal axis 26, which is non-rotatably connected to the drive section 34 of the pump rotor 24. In order to secure the rotational link 44 to the drive section 34, a locking nut 48 is provided, screwed onto the drive section 34.

The housing shell 14 runs substantially parallel to the rotor 38, or rotational link 44, as is clear form FIGS. 3 to 5, and covers said rotor, or rotational link, in a protective manner. The housing shell 14 has a rise 50 encompassing the locking nut 48 in the region of the rotational axis 26.

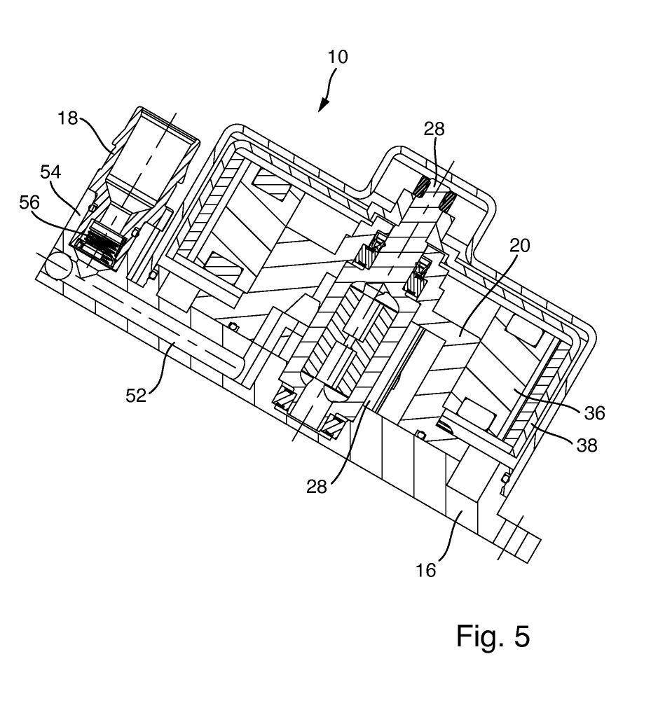

It is clear from the cross-sectional view of FIG. 5 that a pressure channel 52 is provided in the housing floor 16, which connects the pump chamber 20 to the vacuum connection 18. The vacuum connection 18 is designed thereby as a connecting part inserted in a recess 54 provided on the housing floor 16. A check valve 56 is provided in the connecting part.

A bore-hole is provided on the pressure side of the pump chamber 20, not shown in the figures, in the housing floor, through which air can be suctioned off when the rotary vane pump 10 is in operation.

In the second embodiment of a rotary vane pump 60 shown in FIGS. 6 to 8, the components corresponding to the first rotary vane pump 10 are indicated with corresponding reference symbols.

The embodiment 60 according to FIGS. 6 to 10 differs from the embodiment illustrated in FIGS. 3 to 5 in that the motor rotor 38 is rotatably disposed between the pump housing 22 and the motor stator 36. A gap 62 is provided between the pump housing 22 and the motor stator 36, which is non-rotatably disposed on the housing floor 16, in which gap the motor rotor 38 engages. The permanent magnets 42 are provided on the motor rotor 38, on the side facing the motor stator 36. The motor rotor 38 is also implemented as a bell-shaped rotational link 44 in the rotary vane pump 60, which, in corresponding to the rotary vane pump 10, is disposed on the drive section 34 of the pump rotor 24.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A rotary vane pump for generating a vacuum, having a pump housing that delimits a pump chamber, having a pump rotor that can rotate in the pump housing, and having at least one vane in the pump rotor, supported such that it can be radially displaced, for dividing the pump chamber, wherein an electric drive is provided for driving the pump rotor, wherein the electric drive has a motor stator and a motor rotor, wherein the motor stator and the motor rotor radially encompass the pump housing, wherein the motor stator is non-rotatably disposed around or on the pump housing, and the motor rotor is disposed on the side of the motor stator facing away from the pump housing, wherein an overall housing is provided, which accommodates the electric drive and the pump housing, and the overall housing has a housing floor and a housing shell, wherein the housing floor, together with the pump housing, delimits the pump chamber.

2. The rotary vane pump according to claim 1, wherein the pump rotor passes through the pump housing in the axial direction, in order to rotatably couple to the motor rotor.

3. (canceled)

4. The rotary vane pump as set forth in claim 1, wherein the motor rotor comprises a rotational link that covers the motor stator and the pump housing, which is rotatably coupled to the pump rotor in the region of its rotational axis.

5. The rotary vane pump as set forth in claim 1, wherein the motor rotor is rotatably disposed between the pump housing and the motor stator.

6. The rotary vane pump as set forth in claim 4, wherein the motor rotor comprises a rotational link covering the pump housing, which is rotationally coupled to the pump rotor in the region of its rotational axis.

7. The rotary vane pump as set forth in claim 1, wherein the rotational link is designed in the shape of a bell.

8. The rotary vane pump as set forth in claim 1, wherein the rotational link has permanent magnets, and in that coils are provided on the motor stator, which can be connected to a current.

9. (canceled)

10. (canceled)

11. The rotary vane pump as set forth in claim 1, wherein the housing shell has a casing section and a cover section, wherein the casing section encompasses, radially, the motor stator, the motor rotor and the rotational link, and the cover section covers, axially, the motor stator, the motor rotor and the rotational link.

12. The rotary vane pump as set forth in claim 1, wherein the pump rotor is rotatably supported, on one hand, in the housing floor, and on the other hand, in the pump housing.

13. The rotary vane pump as set forth in claim 1, wherein the vacuum side of the pump chamber is connected to a vacuum connection via a pressure channel, provided in particular in the housing floor, and/or in that the pressure side of the pump chamber is connected to pressure connection via a pressure channel, provided in particular in the housing floor.

14. The rotary vane pump as set forth in claim 13, wherein a check valve is provided on or in the vacuum connection.

15. The rotary vane pump as set forth in claim 1, wherein only one vane is provided in the pump chamber, the free ends of which rest against the wall delimiting the pump chamber.
